(19) United States
(12) Patent Application Publication
(10) Pub. No.: US 2009/0222537 A1
(43) Pub. Date: Sep. 3, 2009

(54) System And Method For Interactive Instant Networking

(75) Inventors: Andrew D. Watkins, Vancouver (CA); Michael A, Blackstock, Coquitlam (CA); Linda R. Bartram, Vancouver (CA); Barry Jinks, Vancouver (CA)

Correspondence Address: Robert E. Krebs;Thelen Reid & Pries LLP, P.O. Box 640640, San Jose, CA, 95164-0640, US

(73) Assignee: Colligo Newworks, Inc., a Canadian Corporation

(21) Appl. No.: 12/344,098

(22) Filed: Dec. 24, 2008

Related U.S. Application Data
(62) Division of application No. 11/003,989, filed on Dec. 2, 2004.
(60) Provisional application No. 60/527,533, filed on Dec. 4, 2003.

(51) Int. Cl. G06F 15/16

(52) U.S. Cl. 709/221

(57) ABSTRACT

Interactive instant networking may be achieved by receiving an indication to change from a current network mode to another network mode, disabling a collaboration authority DHCP server if the current network mode comprises a collaboration authority instant network mode, enabling the collaboration authority DHCP server if the current network mode does not comprise the collaboration authority instant network mode, issuing a DHCP IP address request to receive an IP address, and repeating the issuing until a unique IP address is received. The indication may be responsive to a user toggling an application-level user interface button.

### CROSS REFERENCE TO RELATED APPLICATIONS

The present application is a divisional of co-pending U.S. patent application Ser. No. 11/003,989, entitled “System And Method For Interactive Instant Networking,” filed in the name of inventors Andrew D. Watkins, Michael A. Blackstock, Linda R. Bartram and Barry Jinks on Dec. 2, 2004, assigned to Colligo Networks, Inc. which claims the benefit of provisional patent application No. 60/527,533 filed Dec. 4, 2003, entitled “System and Method for Interactive Instant Networking”.

This application is related to the following:

U.S. patent application Ser. No. 10/043,207, filed Jan. 14, 2002 in the name of inventors, Michael A. Blackstock, Andrew D. Watkins, Henk Spaay, Mathieu P. George and Nicholas J. Sawadsky, entitled “Method for Discovering and Discriminating Devices on Local Collaborative Networks to Facilitate Collaboration Among Users”, Attorney Docket No. 34700-000003, commonly assigned herewith; and

U.S. patent application Ser. No. 10/206,009, filed Jul. 25, 2002 in the name of inventors Linda R. Bartram, Michael Blackstock and Henk Spaay, entitled “Method for Context Based Discovery and Filtering of Portable Collaborative Networks”, Attorney Docket No. 34700-000008, commonly assigned herewith.

### FIELD OF THE INVENTION

The present invention relates to the field of computer science. More particularly, the present invention relates to a system and method for interactive instant messaging.

### BACKGROUND OF THE INVENTION

There is a need for users to be able to communicate and share information securely when using computing devices such as laptops or handhelds. This is often difficult when the user is mobile. In some situations, existing networking infrastructure can be used, but in other cases no predefined network structure is available, and users have to connect in ad-hoc networks. An ad-hoc (or “spontaneous”) network is a local area network or other small network, especially one with wireless or temporary plug-in connections, in which some of the network devices are part of the network for only the duration of a communications session or, in the case of mobile or portable devices, while in close proximity to the rest of the network. As a user moves to different locations, the collection of available networks changes. Thus, the user must configure and use different networks according to what is available.

The most common technology for ad-hoc networks is wireless IEEE 802.11 IP-based networking. Configuring and switching between wireless networks is complicated, requiring the user to operate system utilities to set network parameters such as the Service Set Identifiers (SSIDs) and special security keys. For inexperienced system users, this is unnecessarily complex. It would be desirable if users could access their various networks from their end-user applications, and if they could simply select these networks without needing to perform complicated configuration operations. Moreover, using current utilities, the user typically must wait for approximately 80 seconds for the ad-hoc network to be ready before the network switchover is complete.

A variety of network management utilities exist to monitor and switch between network types. These network management utilities are typically run as standalone utilities, often associated with a particular hardware network adapter used or with the operating system itself. Unfortunately, the utilities still experience the network switchover delay discussed above.

The “AirCQ” application, available from Lodesoft Networks of The People's Republic of China, is a small peer-to-peer messaging and file sharing utility that features a networking button and a set of options in a user interface. Pressing the button launches a list of networking options. The list of networks is shown with standard information similar to typical networking utilities. Unfortunately, the AirCQ application provides no way to determine which networks are related to the AirCQ application. Additionally, the AirCQ application does not optimize the network switchover time beyond the standard Windows method. Also, the AirCQ application requires that network parameters be entered manually.

U.S. patent application Ser. No. 10/206,009 discloses setting up relatively small subsets of the physical network that correspond to one or more contexts. Exemplary contexts include one or more locations, purposes, goals, or projects. This context or session is called a portable collaborative network (PCN) since it can be set up anywhere, overlay any physical network (i.e. is portable) and is created as needed for the purpose of collaboration activities such as messaging, data sharing and other forms of information between network users. PCNs can be used with any physical network, and the combination of physical network selection and PCN overlay in the user interface provides the user with great flexibility in how and with whom the user can share information over a network.

When a network device changes to a different network, it must obtain a different IP address for that network. Three common methods for obtaining that address are discussed below. One solution obtains a static address that has been reserved for the particular device. Another solution obtains the address from a DHCP (Dynamic Host Configuration Protocol) server. Another solution uses an address generation method (e.g. Automatic Private IP Addressing (APIPA)) local to the device, which generates an ad hoc or link-local address in the defined range, currently the 169.254.xxx.xxx range defined by the Internet Assigned Numbers Authority (IANA).

FIG. 1 illustrates how these methods for obtaining an IP address apply when switching networks. When the user instructs the system to change networks (100), the device broadcasts a DHCP discover message on the new network (105). If there is a network DHCP server present (i.e., it is an infrastructure network), the DHCP server responds with an IP address (115). If a DHCP server is not present, the request times out (typically after approximately 80 seconds) (120) and the system has to generate its own address using an address generation method local to the device (125). Once the address has been obtained, the system determines whether the address is unique (130). If the address is not unique, the address request or generation step (115, 125) is repeated until a unique address is obtained, at which point the new IP address is used (135).

Accordingly, a need exists in the art for a simplified solution that allows mobile network users to communicate securely using mobile communications devices. A further need exists for such a solution that decreases the network switching time.

### BRIEF DESCRIPTION OF THE INVENTION

Interactive instant networking may be achieved by receiving an indication to change from a current network mode to another network mode, disabling a collaboration authority DHCP server if the current network mode comprises a collaboration authority instant network mode, enabling the collaboration authority DHCP server if the current network mode does not comprise the collaboration authority instant network mode, issuing a DHCP IP address request to receive an IP address, and repeating the issuing until a unique IP address is received. The indication may be responsive to a user toggling an application-level user interface button.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a flow diagram that illustrates network switching.

FIG. 2A is a flow diagram that illustrates a method for network switching using a collaboration authority DHCP server in accordance with one embodiment of the present invention.

FIG. 2B is a flow diagram that illustrates a method for network switching by modifying an APIPA timeout value in accordance with one embodiment of the present invention.

FIG. 3 is a user interface diagram that illustrates an instant network button in accordance with one embodiment of the present invention.

FIG. 4 is a user interface diagram that illustrates use of an instant network button in accordance with one embodiment of the present invention.

FIG. 5 is a user interface diagram that illustrates extended options for network switching in accordance with one embodiment of the present invention.

FIG. 6 is a user interface diagram that illustrates automatic network parameter generation in accordance with one embodiment of the present invention.

### DETAILED DESCRIPTION

Embodiments of the present invention are described herein in the context of a system and method for interactive instant networking. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with one embodiment of the present invention, the components, process steps, and/or data structures may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, or a stand-alone device. The process can be implemented as instructions executed by such hardware, hardware alone, or any combination thereof. The software may be stored on a program storage device readable by a machine.

In addition, those of ordinary skill in the art will recognize that devices of a less general purpose nature, such as hardwired devices, field programmable logic devices (FPLDs), including field programmable gate arrays (FPGAs) and complex programmable logic devices (CPLDs), application specific integrated circuits (ASICs), or the like, may also be used without departing from the scope and spirit of the inventive concepts disclosed herein.

In accordance with one embodiment of the present invention, the method may be implemented on a data processing computer such as a personal computer, workstation computer, mainframe computer, or high performance server running an OS such as Solaris® available from Sun Microsystems, Inc. of Santa Clara, Calif., Microsoft*) Windows® XP and Windows® 2000, available form Microsoft Corporation of Redmond, Wash., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet.

In the context of the present invention, the term “network” comprises local area networks, wide area networks, the Internet, cable television systems, telephone systems, wireless telecommunications systems, fiber optic networks, ATM networks, frame relay networks, satellite communications systems, and the like. Such networks are well known in the art and consequently are not further described here.

In the context of the present invention, the term “collaboration authority” describes an entity that provides an interactive instant networking service.

In the context of the present invention, a regular network (RN) mode describes a default network mode set by an external network manager or utility.

In the context of the present invention, a CAIN mode describes a network mode where a collaboration authority manages and configures the network.

Embodiments of the present invention relate to identifying, discovering, connecting to, and switching between wireless networks (such as a wireless LAN or an ad hoc network) for collaboration. A relatively efficient discovery method and relatively simple user interface make this approach feasible for all types of computing devices, including resource-constrained devices such as those having relatively restricted bandwidth, screen size, or processing power with respect to a typical desktop computer.

The method of distributing and discovering shared sessions disclosed herein is well suited for peer-to-peer networking configurations. Embodiments of the present invention may be extended to collaborative networks as described in U.S. patent application Ser. No. 10/043,207, but can be extended to other collaborative networks as well.

Collaborative network technology makes it relatively easy for users to collaborate in a variety of IP-based networks by providing an instant networking method in the user interface. These networks can include both infrastructure-based networks using routers or wireless access points and ad-hoc networks in which peers (nodes) connect directly to each other with no extra routing hardware or software. The networks are usually, but not exclusively, wireless.

According to one embodiment of the present invention, a collaboration authority application program allows users to flexibly monitor and switch between physical networks in real-time from the application, without having to resort to using low-level networking utilities. An instant networking button of a user interface in communication with the collaboration authority application program allows the user to switch immediately between a regular network (the default network mode set by an external network manager or utility) and a network defined by the collaboration authority. The collaboration authority application manages the hardware reconfiguration, the software reconfiguration, or both, required to attach and detach the peer from a particular network. In particular, the collaboration authority application provides an efficient method of switching from an infrastructure network to an ad-hoc network using a peer-hosted, dedicated private address server. The collaboration authority application smoothly manages coexistence with other wireless managers. The collaboration authority application takes control from other wireless managers and hand it backs appropriately, allowing the user to re-establish infrastructure settings or other ad-hoc settings, as well including security, Virtual Private Networking (VPN), etc.

According to one embodiment of the present invention, the collaboration authority application allows a collaboration authority peer to detect what other networks are currently active. In the case of ad-hoc networks, the peer can determine if they are associated with other collaboration authority peers. The user can define network profiles to activate with optional security for both infrastructure and ad-hoc networks.

### Collaboration Authority Instant Networking Method

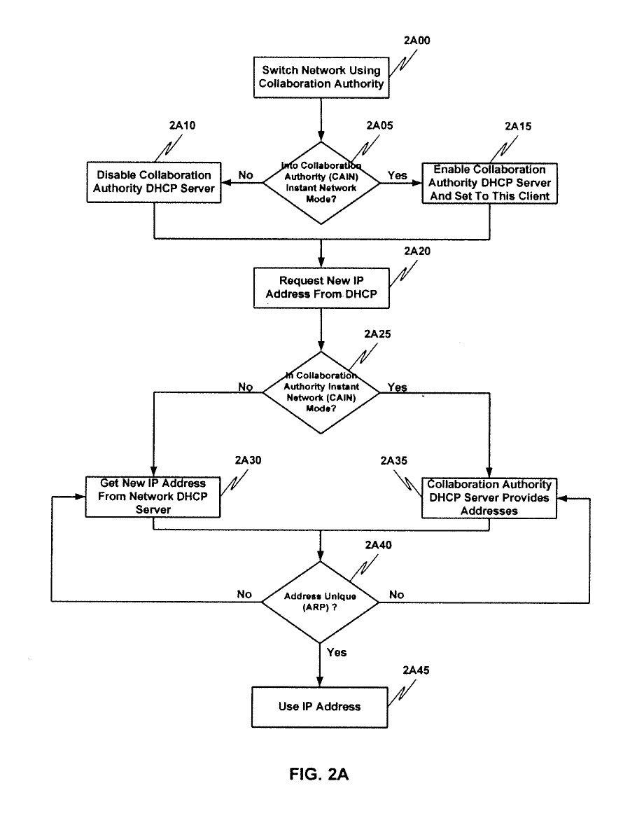

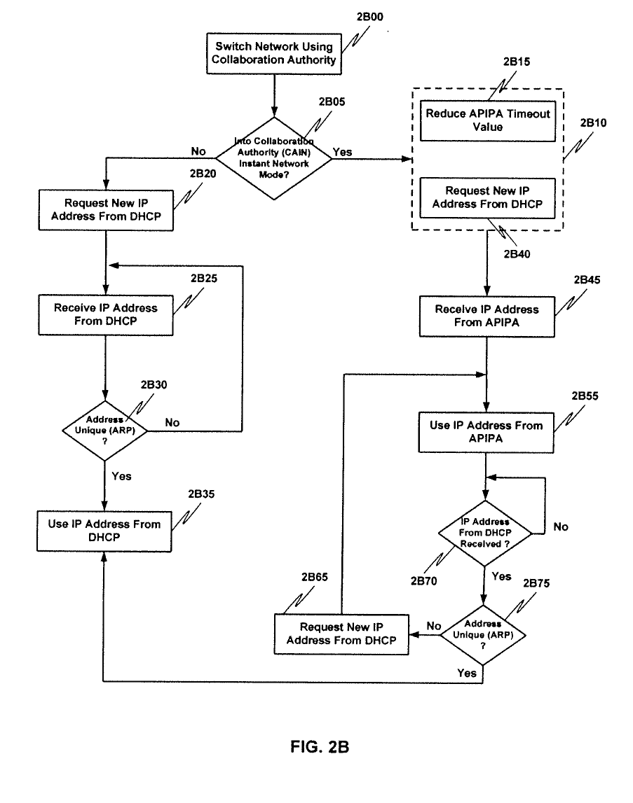

FIG. 2A is a flow diagram that illustrates network switching using a collaboration authority DHCP server in accordance with one embodiment of the present invention. A local DHCP server runs with the Collaboration authority application, thus reducing the time it takes to switch into an ad-hoc network. The DHCP server responds only to requests from that particular device. In other words, the DHCP server is client-specific.

When the user tells the system to switch networks using the instant networking controls from the Collaboration authority application (2A00), the system checks its mode (2A05). If at 2A05 the system is leaving a collaboration authority interactive network (CAIN) mode, the DHCP server is disabled at 2A10. If at 2A05 the system is entering CAIN mode, the local DHCP server is enabled at 2A15. In addition, the DHCP server is told to respond only to requests from the MAC address of the device's network adapter. When the device subsequently sends out its DHCP request (2A20), the local DHCP server responds immediately with an IP address, thereby avoiding the timeout of previous solutions.

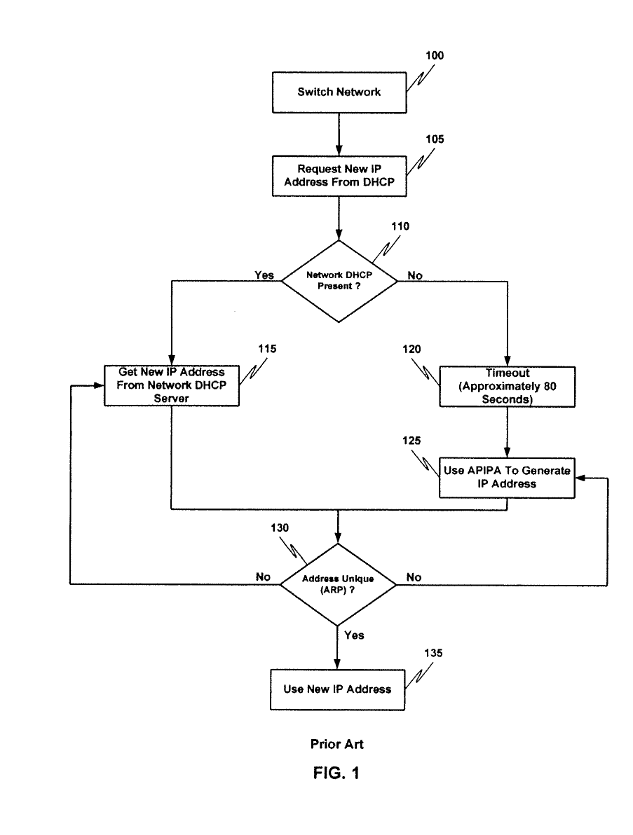

As shown in FIG. 2A, the location of the DHCP server differs from the location of the DHCP server in FIG. 1. When entering infrastructure mode, the network DHCP server responds to the request (the local DHCP server also sees the request, but does not respond because it has been disabled). When entering CAIN mode, the network DHCP server never sees the request, but the local server does and will respond because it has been enabled. In both cases an APIPA address is assigned if the DHCP server does not respond.

FIG. 2B is a flow diagram that illustrates network switching by modifying an APIPA timeout value in accordance with one embodiment of the present invention. When in CAIN instant networking mode, the APIPA timeout value is reduced, thus reducing the time it takes to switch into an ad-hoc network. An IP address assigned by APIPA is used until a unique IP address from a DHCP server is received, at which point the unique IP address received from the DHCP server is used in lieu of the IP address assigned by APIPA. This is explained in more detail below.

When the user tells the system to switch networks using the instant networking controls from the Collaboration authority application (2B00), the system checks its mode (2B05). If at 2B05 the system is leaving a collaboration authority interactive network (CAIN) mode, the APIPA timeout value is restored at 2B10. Alternatively, the APIPA timeout value can be restored after a DHCP address is determined to be unique at reference numeral 2B75. If at 2B05 the system is entering CAIN mode, the APIPA timeout value is reduced at 2B15. According to one embodiment of the present invention, the APIPA timeout value is reduced to zero. At 2B40, a new DHCP address is requested from DHCP. As indicated by box 2B10, processes 2B15 and 2B40 may be executed concurrently. At 2B45, an IP address from APIPA is received. At 2B55, the IP address from APIPA is used. At 2B70, a determination is made regarding whether an IP address from DHCP has been received. If an IP address from DHCP has been received, at 2B75 a determination regarding whether the received DHCP address is unique. If the received DHCP address is unique, at 2B65 a request for a new IP address from DHCP is made, and the process continues at 2B55 where the IP address from APIPA is used until a unique IP address is received from DHCP.

Still referring to FIG. 2B, when a unique IP address is received from DHCP, the DHCP address is used in lieu of the IP address from APIPA. Thus according to this embodiment of the present invention, when the device sends out its DHCP request, the local DHCP server responds relatively quickly with an IP address, thereby reducing or eliminating the timeout of previous solutions.

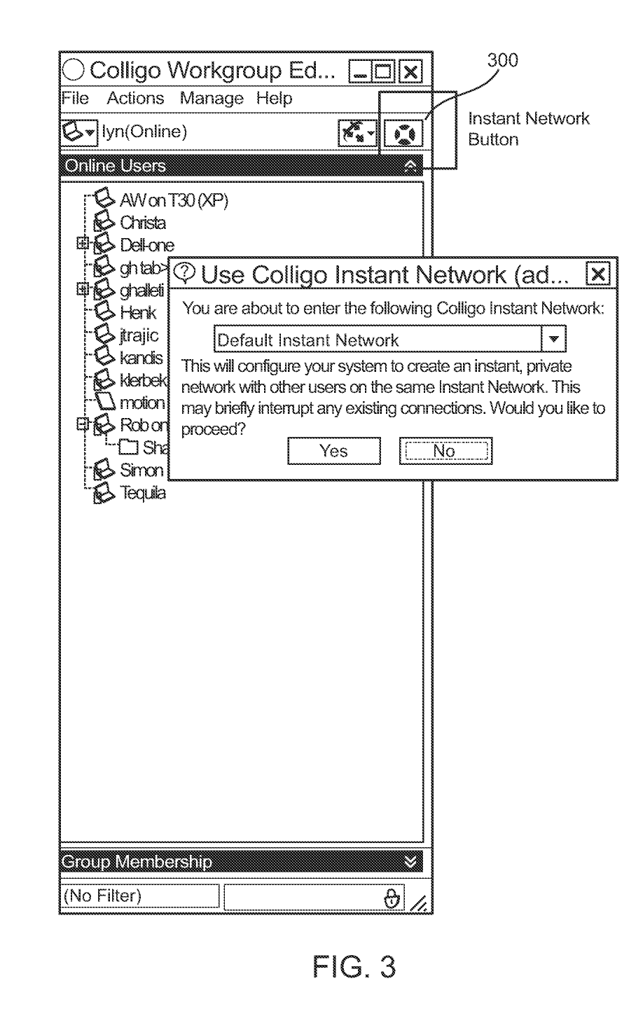

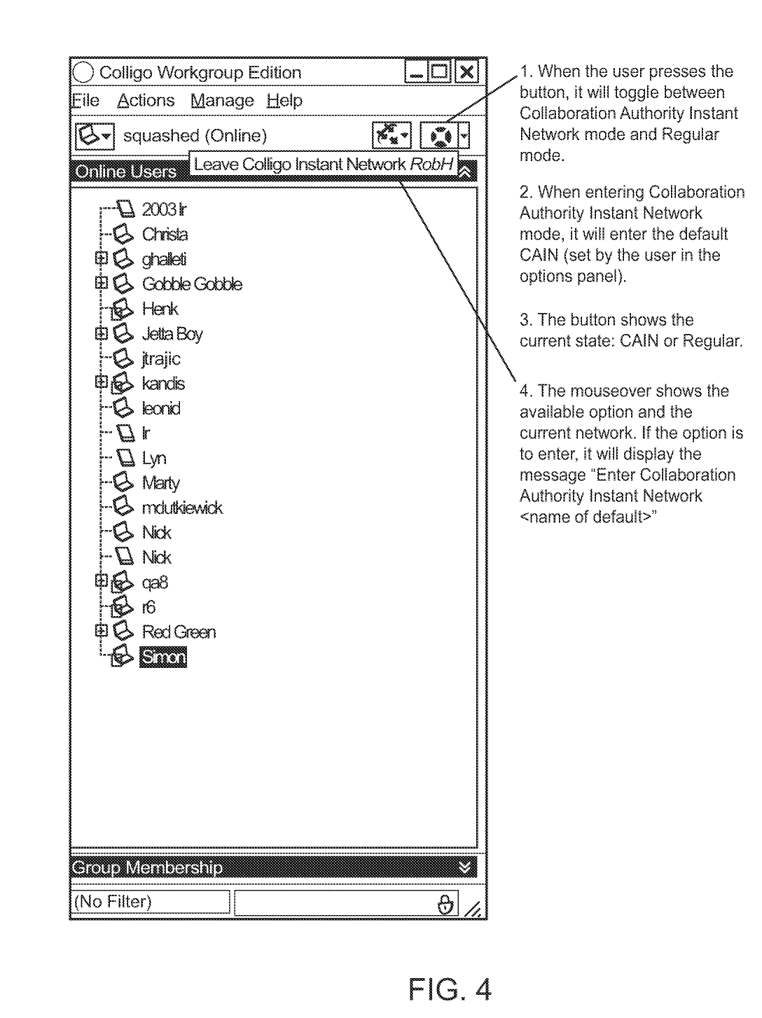

FIGS. 3-5 illustrate aspects of an instant networking user interface in accordance with embodiments of the present invention. Referring to FIG. 3, an instant networking button 300 displays the network state and mode to the user: RN mode or CAIN mode. Various other graphical representations may be used to indicate the network state and mode as well.

### Instant Network Button

According to one embodiment of the present application, an application-level user interface in communication with the collaboration authority application provides a single button 300 to allow a user to toggle or switch between CAIN mode and RN mode upon clicking the button once, without requiring user modification of network configuration parameters. In more detail, if the current networking mode is CAIN mode, a single click of the button will switch the user from CAIN mode to RN mode. Likewise, if the current networking mode is RN mode, a single click of the button will switch the user from RN mode to CAIN mode. The network configuration parameters may be obtained from a predetermined user-defined network profile. Network profiles are described in more detail below.

According to one embodiment of the present invention, the RN mode comprises an infrastructure network, and the CAIN mode comprises an ad-hoc network, allowing the user to easily and efficiently change between the two modes with minimal user intervention required.

### Changing From RN Mode to CAIN Mode

According to one embodiment of the present invention, upon toggling the instant network button while in RN mode, the collaboration authority application takes control of the network adapter wireless card and changes the network settings to the default CAIN. This default can be set in the user preferences. Exemplary settings include a Last CAIN, a user-specified CAIN from a stored CAIN profile, or a System-specified default. Next, the device is switched to the CAIN. In some cases, the resident network control manager for the card or the operating system will detect the application control and disable itself; in other cases the network control manager will continue to run.

### Changing From CAIN Mode to RN Mode

According to one embodiment of the present invention, upon toggling the instant network button while in CAIN mode, the collaboration authority application returns control to the resident network manager and resets it. Standard network managers may automatically restore their last known setting. If no network manager is enabled, the user will remain disconnected until the user starts a network manager.

### Network Discovery and Selection

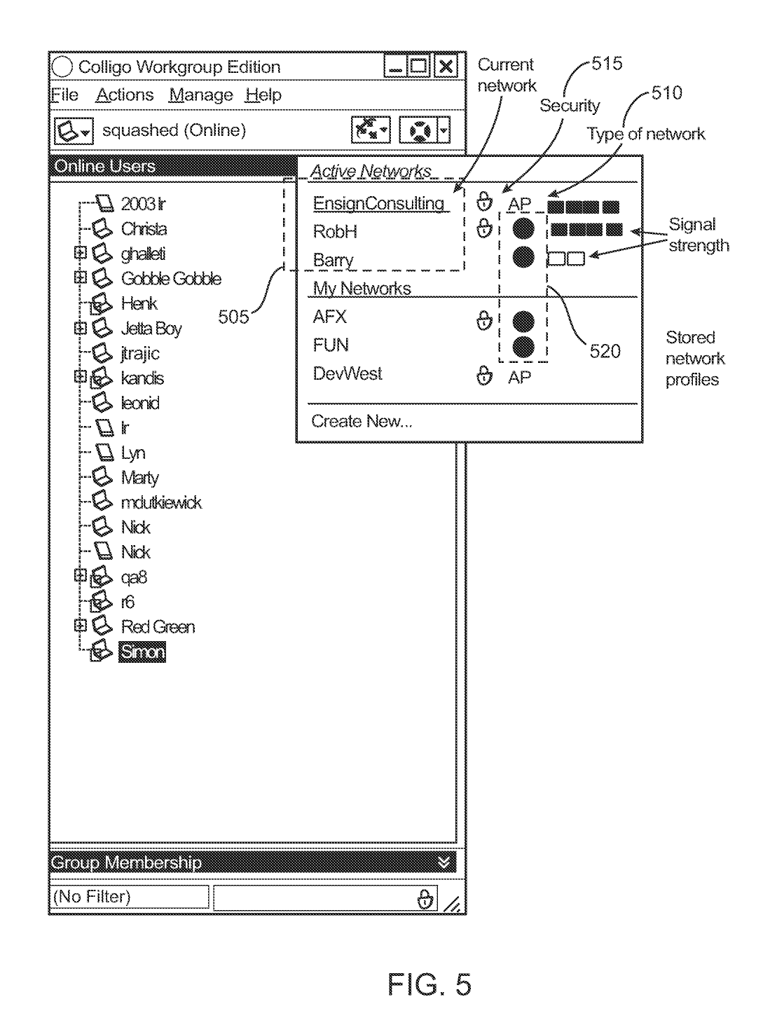

The CAIN user interface may feature an extended set of options. FIG. 5 shows an exemplary CAIN user interface with an extended set of options. As shown in FIG. 5, without having to select a network, the user can discover (1) which networks are active in the area 505, (2) what kind of network it is (i.e. infrastructure or ad-hoc) 510, (3) whether the network is protected by IEEE 802.11 security 515, and (4) whether it is a Collaboration authority instant network (an ad-hoc network that has been activated by another Collaboration authority application on another device) 520.

Also shown in FIG. 5 are the user's CAIN profiles and other network profiles. The user may elect to switch to another network on the list. If the network (active or profile) is not another CAIN, the mode information on the instant networking button is updated to display RN.

According to one embodiment of the present invention, the collaboration authority application identifies the ad-hoc CAIN to other users as a collaboration authority instant network by appending a special tag to the networks' identifier. This is described in more detail below. Networks detected with this tag in the identifier are displayed as CAINs.

### Network Profiles: Creating, Configuring and Saving

The user may define network profiles in advance that contain the required parameters for an IEEE 802.11 network. These parameters comprise the network identifier (the SSID). These parameters may also comprise a security setting (a hexadecimal key), and an option to set this network as the default CAIN. Each network profile can be saved. Upon selecting the network profile from the displayed list, the user is switched into that network. If it is an infrastructure network and the network access point is currently unavailable, the user is warned.

### Automatic Network Configuration Parameter Generation

According to embodiments of the present invention, a user interface associated with the collaboration authority application provides a mechanism for automatic generation of one or more network security keys, one or more network identifiers (SSIDs), or both, thus shielding that complexity from the user.

Regarding automating generation of one or more SSIDs, the collaboration authority application simplifies defining the required IEEE 802.11 parameters by generating the SSID from the network profile name. If the network is a CAIN, the collaboration authority application adds a small CAIN-specific tag to the SSID (for example, “_CLGO”), that identifies it as a CAIN. Alternatively, the SSID may be based at least in part on a simple passphrase. A simple passphrase is easier to remember than a long string of alphanumeric characters. Alternatively, a user may enter the SSID manually. A CAIN, however, will have the CAIN identifier tag attached.

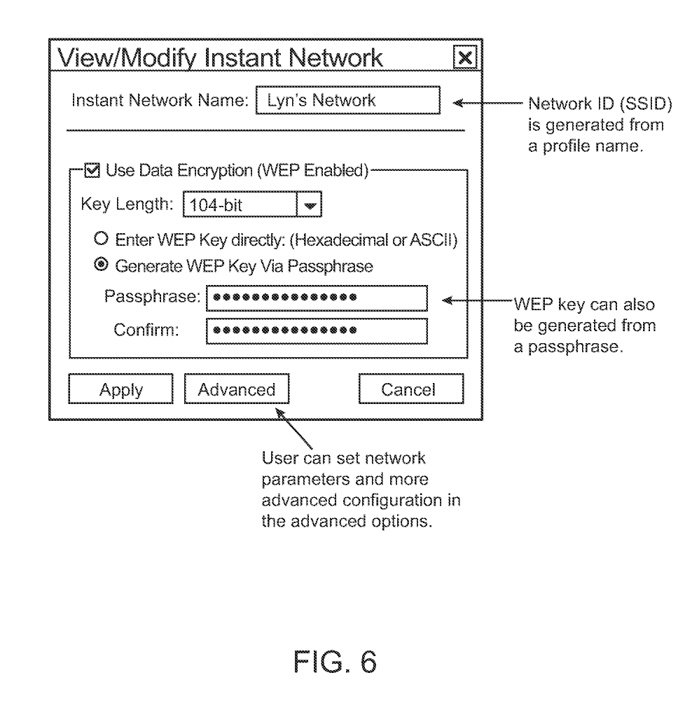

Regarding automatic generation of one or more network security keys, the collaboration authority application simplifies defining the required IEEE 802.11 parameters by generating the security key from a simple passphrase. FIG. 6 illustrates generating a network security key based at least in part on a passphrase. According to another embodiment of the present invention, the user interface provides full control for a user to enter security keys.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

1-20. (canceled)

21. A computing device comprising:
a user interface displayable on a computer screen and comprising at least one user control that allows a user to launch access to an ad-hoc network; and
at least one computer-readable medium storing computer-readable instructions which, when executed, cause the computing device to, responsive to the user control:
change a mode of a wireless card associated with the computing device from an infrastructure mode to an ad-hoc mode; and
switch the computing device to the ad-hoc network.

22. The computing device of claim 21 wherein the at least one user control comprises a button.

23. The computing device of claim 21 wherein the ad-hoc network comprises a default ad-hoc network that is specified in a user preferences file for the user.

24. The computing device of claim 23 wherein the default ad-hoc network comprises a last ad-hoc network.

25. The computing device of claim 23 wherein the default ad-hoc network comprises a user-specified ad-hoc network from a ad-hoc network profile.

26. The computing device of claim 23 wherein the default ad-hoc network comprises a system-specified ad-hoc network.

27. The computing device of claim 21 wherein the network name comprises a service set identifier (SSID) with a tag that identifies it as a specific type of ad-hoc network.

28. The computing device of claim 27 wherein the tag indicates one or more applications running on the ad-hoc network, the one or more applications comprising one or more of a data sharing application and a collaboration application.

29. The computing device of claim 21 wherein the tag is pre-pended to each of the available ad-hoc networks.

30. A computing device comprising:
a user interface displayable on a computer screen, the user interface comprising at least one user control that allows a user to leave an ad-hoc network; and
at least one computer-readable medium storing computer-readable instructions which, when executed, cause the computing device, upon leaving the ad-hoc network, to restore network connectivity settings on the computing device to a state prior to the access to the ad-hoc network.

31. The computing device of claim 30 wherein the at least one user control comprises a button.

32. A computer implemented method comprising:
displaying a user interface on a computer screen of a computing device, the user interface comprising at least one user control that allows a user to launch access to an ad-hoc network; and
responsive to the user control;
changing a mode of a wireless card associated with the computing device from an infrastructure mode to an ad-hoc mode; and
switching the computing device to the ad-hoc network.

33. The method of claim 32 wherein the at least one user control comprises a button.

34. The method of claim 32 wherein the ad-hoc network comprises a default ad-hoc network that is specified in a user preferences file for the user.

35. The method of claim 34 wherein the default ad-hoc network comprises a last ad-hoc network.

35. The method of claim 34 wherein the default ad-hoc network comprises a user-specified ad-hoc network from a ad-hoc network profile.

37. The method of claim 34 wherein the default ad-hoc network comprises a system-specified ad-hoc network.

38. The method of claim 32 wherein the network name comprises a service set identifier (SSID) with a tag that identifies it as a specific type of ad-hoc network.

39. The method of claim 38 wherein the tag indicates one or more applications running on the ad-hoc network, the one or more applications comprising one or more of a data sharing application and a collaboration application.

40. The method of claim 32 wherein the tag is pre-pended to each of the available ad-hoc networks.

41. A computer implemented method comprising:
displaying a user interface on a computer screen of a computing device, the user interface comprising at least one user control that allows a user to leave an ad-hoc network; and
upon the user leaving the ad-hoc network, restoring network connectivity settings on the computing device to a state prior to the access to the ad-hoc network.

42. The method of claim 41 wherein the at least one user control comprises a button.
